(19) United States
(12) Patent Application Publication
(10) Pub. No.: US 2023/0231512 A1
(43) Pub. Date: Jul. 20, 2023

(54) SOLAR PANEL FRAME STRUCTURE

(71) Applicant: Jia-Shou WANG, New Taipei City (TW)

(72) Inventor: Jia-Shou WANG, New Taipei City (TW)

(21) Appl. No.: 17/575,993

(22) Filed: Jan. 14, 2022

(51) Int. Cl. H02S 30/10; H02S 20/30

(52) U.S. Cl. CPC H02S 30/10; H02S 20/30

(57) ABSTRACT

A solar panel frame structure includes a rectangular solar panel having two pairs of opposite sides. Each side frame has a top plate, a vertical plate and a bottom plate. The top plate is arranged above the vertical plate and protrudes from both sides of the vertical plate. The bottom plate is arranged on one side of the vertical plate, the section of the top plate where the top plate and the bottom plate are positioned on the same side of the vertical plate is defined as an inner section, and the section of the top plate where the top plate and the bottom plate are positioned on different sides of the vertical plate is defined as an outer section. An accommodating area is formed between the inner section and the bottom plate for accommodating one side of the solar panel. The vertical plate has a combined section protruding downwards from the bottom plate, and a through hole located in the combined section.

### BACKGROUND OF THE INVENTION

### 1. Field of the Invention

The present invention relates to solar energy equipment and more particularly, to a solar panel frame structure.

### 2. Description of the Related Art

In order to encourage the use of alternative energy sources, solar energy is a kind of green energy that the government is pushing forward. However, solar panels are currently installed in a rectangular frame, and then the rectangular frame is installed on an iron frame outside the roof or the outer wall of the building, and the rectangular frame holding the solar panel is not directly taken as a building material on the roof or used as an exterior wall. In the case of a roof, it is necessary to make a roof on the building and then mount the iron frame on the roof. Finally, the rectangular frame holding the solar panel is fastened to the iron frame using complicated clips or fixtures. Therefore, in the same area, it is equivalent to a two-story roof. This installation method is a waste of space and materials. The main reason is that the overall structure of the solar panel frame used in the past is easy to leak, so it is not suitable for use as a roof directly.

### SUMMARY OF THE INVENTION

The present invention has been accomplished under the circumstances in view. It is the main object of the present invention to provide a solar panel frame structure, which can have better water leakage prevention effect and can be directly used as a roof.

To achieve this and other objects of the present invention, the solar panel frame structure comprises a solar panel and two side frames. The solar panel is rectangular in shape with two pairs of opposite sides. The two side frames are respectively set on a pair of corresponding sides of the solar panel. Each side frame is in the shape of a long strip, comprising a top plate, a vertical plate and a bottom plate. The top plate is arranged above the vertical plate, and protrudes from both sides of the vertical plate. The bottom plate is arranged on one side of the vertical plate. The section of the top plate where the top plate and the bottom plate are positioned on the same side of the vertical plate is defined as an inner section. The section of the top plate where the top plate and the bottom plate are positioned on different sides of the vertical plate is defined as an outer section. An accommodating area is formed between the inner section and the bottom plate for accommodating one side of the solar panel. The vertical plate comprises a combined section protruding downwards from the bottom plate, and a through hole located in the combined section.

Preferably, the outer section of the top plate has a bottom side thereof mounted with an elongated sealing member. The sealing member has a middle part thereof provided with an upper protruding portion when viewed from the short axial section thereof. The upper protruding portion is used to be clamped between two adjacent solar panel frame structures.

Preferably, the top plate of each side frame comprises a series of locking teeth on a bottom side of the outer section.

Preferably, the solar panel frame structure further comprises a shelf plate added to one side of the combined section. The shelf plate comprises an upper section and a lower section in view of the short axial section thereof. The upper section is provided with a through hole for a bolt to pass through. The lower section is connected to a lower edge of the upper section and extends laterally to one side.

### BRIEF DESCRIPTION OF THE DRAWINGS

FIG. 1 is an oblique top elevational view of a solar panel frame structure in accordance with a first embodiment of the present invention.

FIG. 2 is a sectional view taken along line 2-2 of FIG. 1.

FIG. 3 is similar to FIG. 2, and is a schematic diagram of a second embodiment of the present invention.

FIG. 4 is similar to FIG. 2, and is a schematic diagram of a third embodiment of the present invention.

FIG. 5 is similar to FIG. 2, and is a schematic diagram of a fourth embodiment of the present invention.

FIG. 6 is similar to FIG. 2, and is a schematic diagram of a fifth embodiment of the present invention.

FIG. 7 is an oblique top elevational view of a solar panel frame structure in accordance with a sixth embodiment of the present invention.

FIG. 8 is an exploded perspective view of the solar panel frame structure of the sixth embodiment.

FIG. 9 is an exploded view in an enlarged scale of a part of the sixth embodiment.

### DETAILED DESCRIPTION OF THE INVENTION

First of all, it should be noted that the technical features provided by the present invention are not limited to the specific structures, uses and applications described in the embodiments. The terms used in the specification are all illustrative terms that can be understood by those with ordinary knowledge in the technical field. The descriptive directional terms such as “front”, “up”, “down”, “rear”, “left”, “right”, “top”, “bottom”, “inside”, and “outside” mentioned in this specification are only exemplary descriptive terms based on the normal usage direction, and are not intended to limit the scope of claims.

Furthermore, as used in the patent scope of this invention application, the singular form of “a”, “an” and “the” and other numerals all include the meaning of the plural. Thus, for example, a reference to “an element” refers to one or more elements and includes equivalents known to those of ordinary skill in the art. All conjunctions used in similar situations should also be understood in their broadest sense. The specific shapes and structural features or technical terms described in the specification should also be construed as including equivalent replacement structures or technical terms for the functions that can be achieved by the specific structures or technical terms.

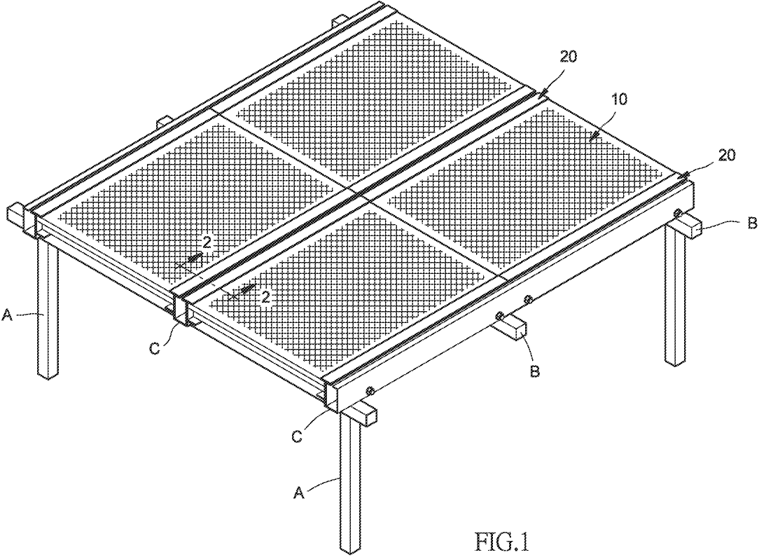

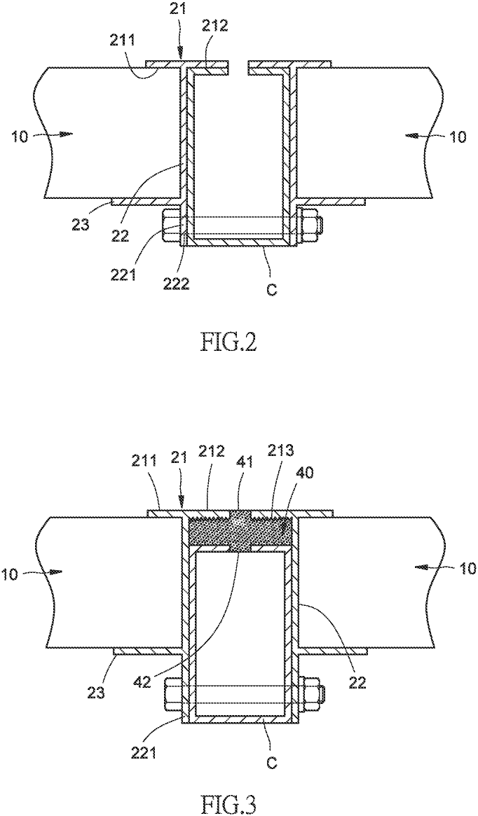

Please refer to FIG. 1 and FIG. 2, the solar panel frame structure of the first embodiment of the present invention is erected on a transverse beam-column component set. The transverse beam-column component set includes: a plurality of columns A, which can stand on the ground or a plane, and a plurality of transverse beams B and a plurality of longitudinal beams C arranged on the top of the columns A in a checkerboard shape. The transverse beams B are below, and the longitudinal beams C are straddling the transverse beams B. The distance between two adjacent longitudinal beams C is used to set the solar panel frame structure. Because the transverse beam-column component set is the basic frame structure of general roof transverse beams, it will not be described in detail here.

This solar panel frame structure in the present invention comprises a solar panel 10 and two side frames 20. The solar panel 10 is rectangular in shape with two pairs of opposite sides.

The two side frames 20 are respectively arranged on a pair of corresponding sides of the solar panel 10. Each side frame 20 is in the shape of a long strip, and each side frame 20 comprises a top plate 21, a vertical plate 22 and a bottom plate 23 from top to bottom when viewed from its short axial section. The top plate 21 is arranged above the vertical plate 22 and protrudes from both sides of the vertical plate 22. so that its cross-section is T-shaped. The bottom plate 23 is arranged on one side of the vertical plate 22 and is parallel to the top plate 21. The section where the top plate 21 and the bottom plate 23 are positioned on the same side of the vertical plate is the inner section 211. and the section where the top plate 21 and the bottom plate 23 are positioned on the different sides of the vertical plate 22 is the outer section 212. An accommodating area is formed between the top plate inner section 211 and the bottom plate 23 for accommodating one side of the solar panel 10. The vertical plate 22 has a portion protruding downwards from the bottom plate 23 as a combined section 221. The direction in which the combined section 221 extends is parallel to the direction in which the vertical plate 22 extends. The vertical plate 22 is provided with at least one through hole 222 in the combined section 221 for bolts to pass through.

In the solar panel frame structure of the present invention, the outer sections 212 of the top plates 21 of the two side frames 20 are respectively set across one longitudinal beam C of the transverse beam-column component set, so that the vertical plates 22 can be in close contact with the longitudinal beam C and the combined sections 221 located on both sides of the longitudinal beam C can sandwich the longitudinal beam C. Then use a bolt to pass through the through holes 222 of the combined sections 221 and the longitudinal beam C for screwing. In this specification, each embodiment of the longitudinal beam takes a C-shaped steel transverse beam as an illustrative example, as shown in FIG. 2, but it is not limited to this. When the notch of each longitudinal beam faces upward, the outer sections 212 of the top plates 21 of the side frames of the solar panel frame structure are respectively set across one longitudinal beam C of the transverse beam-column component set, so the vertical plates 22 can be in close contact with the longitudinal beam C. Then a bolt is inserted through the through holes 222 of the combined sections and the longitudinal beam C is screwed. Then use a bolt to pass through the through holes 222 of the combined sections and the longitudinal beam C for screwing.

As shown in FIG. 3, in the second embodiment of the present invention, the solar panel frame structure also comprises a solar panel 10 and two side frames 20 in this embodiment. The difference from the above first embodiment is that the top plate 21 of each side frame 20 is provided with locking teeth 213 on the bottom surface of its outer section 212 for increasing the frictional force. A sealing member 40 is further provided between the outer section 212 and the longitudinal beam C. The sealing member 40 is elongated, and the middle of the sealing member 40 is provided with an upper protruding portion 41 and a lower protruding portion 42 when viewed from its short axial section. The lower protruding portion 42 can be clamped at the notch of the longitudinal beam C, and the upper protruding portion 41 can be clamped between the two side frames 20 of two adjacent solar panel frame structures. This can increase the closeness between the solar panel frame structure and the longitudinal beam and also increase the waterproof effect. It can also provide an elastic area when the solar panel frame structure undergoes thermal expansion and contraction.

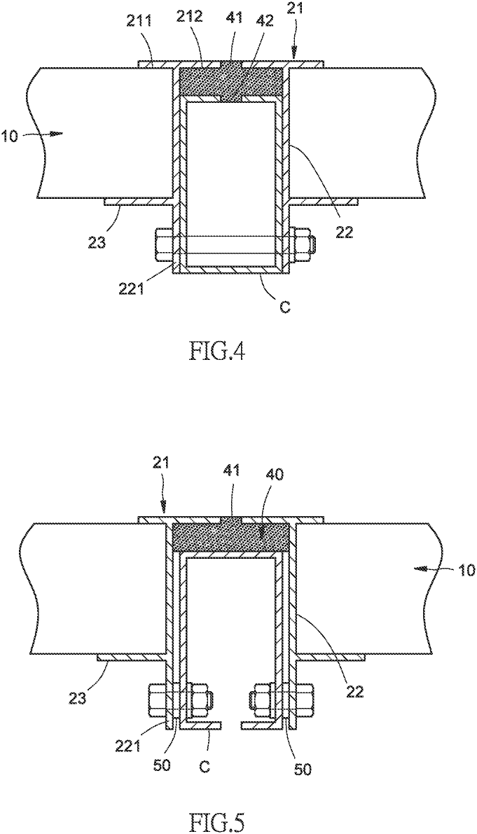

As shown in FIG. 4, in the third embodiment of the present invention, the solar panel frame structure also comprises a solar panel 10 and two side frames 20 in this embodiment. The difference from the first embodiment is that a sealing member 40 is provided between the top plate outer section 212 and the longitudinal beam C. The sealing member 40 is elongated, and viewed from its short axial section, the middle of the sealing member 40 is provided with an upper protruding portion 41 and a lower protruding portion 42. The lower protruding portion 42 can be clamped at the notch of the longitudinal beam C and the upper protruding portion 41 can be clamped between the two side frames 20 of the two adjacent solar panel frame structures.

As shown in FIG. 5, in the fourth embodiment of the present invention, the solar panel frame structure also comprises a solar panel 10 and two side frames 20 in this embodiment. The difference from the third embodiment is that the notch of the longitudinal beam C faces downward, and a sealing member 40 is arranged between the top plate 21 and the longitudinal beam C. The sealing member 40 is elongated, and an upper protruding portion 41 is arranged in the middle of the sealing member 40 when viewed from its short axial section, which is clamped between two side frames 20 of the two adjacent solar panel frame structures. The width of the sealing member 40 is larger than the width of the longitudinal beam C, so there will be a gap between the vertical plate 22 and the longitudinal beam C. When passing through the through hole 222 of the combined section 221 with a bolt, a gasket 50 is added between the vertical plate 22 and the longitudinal beam C, so that the combination between the vertical plate 22 and the longitudinal beam C is more elastic, and it also provides an elastic area for the solar panel frame structure to expand and contract during thermal expansion and contraction.

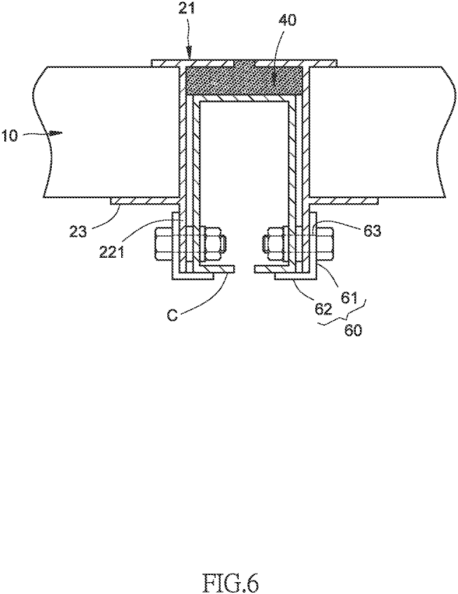

As shown in FIG. 6, in the fifth embodiment of the present invention, the solar panel frame structure also comprises a solar panel 10 and two side frames 20 in this embodiment. In the present embodiment, the notch of the longitudinal beam C faces downward, and a sealing member 40 is provided between the top plate 21 and the longitudinal beam C. The sealing member 40 is elongated, and an upper protruding portion 41 is arranged in the middle of the sealing member when viewed from its short axial section, which is clamped between two side frames 20 of two adjacent solar panel frame structures. The difference from the fourth embodiment is that a shelf plate 60 is added to one side of the combined section 221. The shelf plate 60 has an upper section 61 and a lower section 62 as viewed from its short axial section. The upper section has a through hole 63 for a bolt to pass through, and the lower section 62 is continuous with the lower edge end of the upper section 61 and extends laterally to one side. Before passing through the through hole 222 of the combined section 221 with a bolt, the shelf plate 60 is passed through the bolt with the through hole 63 first, and then the bolt is passed through the through hole 222 of the combined section 221. In this way, the combined section 221 of the side frame vertical plate 22 can be sandwiched between the upper section 61 of the shelf plate 60 and the longitudinal beam C, and the lower section 62 of the shelf plate 60 can laterally extend to the lower edge of the longitudinal beam C, and the end of the combined section 221 can also abut against the lower section 62 of the shelf plate 60 to increase the stability of the combination.

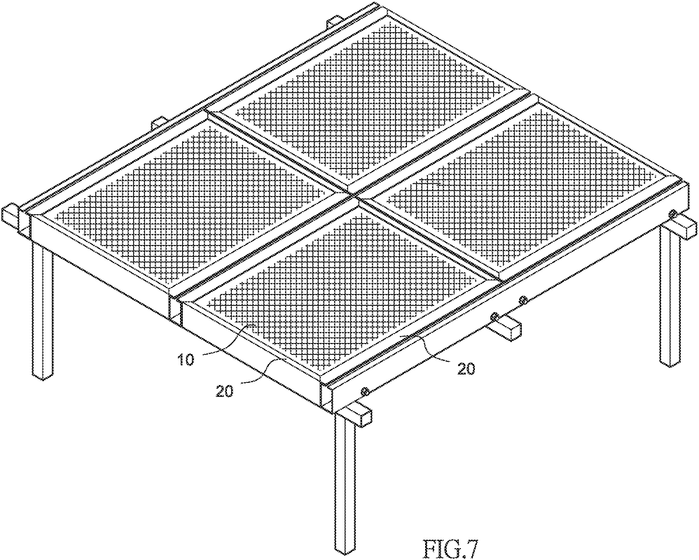

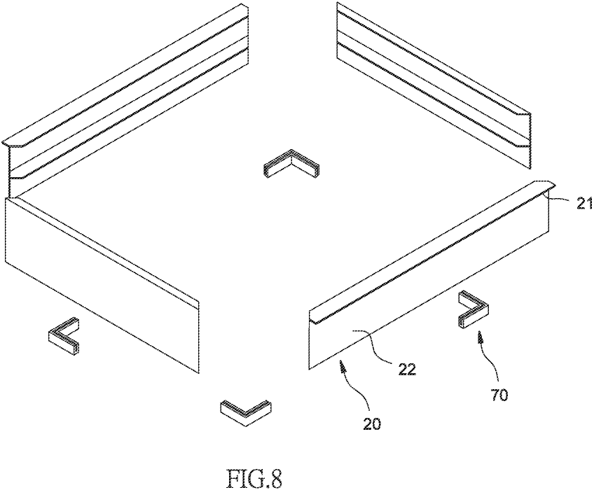

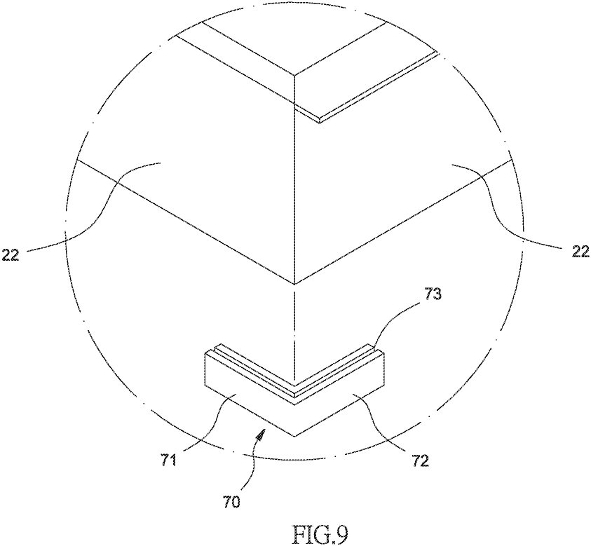

As shown in FIGS. 7-9, in the sixth embodiment of the present invention, the solar panel frame structure comprises a solar panel 10 and four side frames 20 in this embodiment. The four side frames are arranged in two pairs, and set at the two pairs of opposite sides of the solar panel. The structure of each side frame 20 is the same as that of the side frames of the first embodiment, and is in the shape of a long strip. Viewed from its short axial section, a top plate 21, a vertical plate 22 and a bottom plate 23 are respectively provided from top to bottom. The top plate 21 of each of the side frames at the two long sides is arranged above the associating vertical plate 22 and protrudes from both sides of the associating vertical plate 22, so that its cross-section is T-shaped. The top plate 21 of each of the side frames simply protrudes from one side of the associating vertical plate 22, so that its cross-section is F-shaped.

The bottom plate 23 of each side frame is arranged on one side of the associating vertical plate 22 and is parallel to the associating top plate 21. The vertical plate 22 has a portion protruding downwards from the bottom plate 23 as a combined section 221. and the direction in which the combined section 221 extends is parallel to the direction in which the vertical plate 22 extends. The solar panel 10 is also arranged between the top plate 21 and the bottom plate 23.

The difference from the first embodiment is that the solar panel frame structure further comprises a fixing angle plate 70. The fixing angle plate has a first section 71 and a second section 72. An included angle is contained between the first section 71 and the second section 72. The included angle is preferably 90 degrees, so that the first section 71 and the second section 72 are L-shaped. The first section 71 and the second section 72 are respectively provided with a mounting groove 73. The fixing angle plate 70 is disposed below the adjoining place where a horizontal side frame adjoins a vertical side frame, so that the end sections of the vertical plates 22 of the two adjacent side frames can be inserted and fixed in the mounting grooves 73 of the first section 71 and the second section 72 respectively, so as to increase the stability of the combination of the two side frames.

With the structure of the sixth embodiment of the present invention, not only the arrangement of side frames on the four sides of the solar panel is beneficial to the fixation of the solar panel, the transverse beam and the longitudinal beam, moreover, by adding the setting of the fixing angle plates, the joint of the side frames in horizontal and vertical can be more stable, so as to reduce the damage to the solar panel caused by the distortion of the frame structure.

What is claimed is:

1. A solar panel frame structure, comprising:
a solar panel, said solar panel being rectangular in shape with two pairs of opposite sides; and
two side frames respectively set on a pair of corresponding sides of said solar panel, each said side frame being in the shape of a long strip, each said side frame comprising a top plate, a vertical plate and a bottom plate, said top plate being arranged above said vertical plate and protruding from both sides of said vertical plate to show a T-shaped cross-section, said bottom plate being arranged on one side of said vertical plate, the section of said top plate where said top plate and said bottom plate are positioned on the same side of said vertical plate being defined as an inner section, the section of said top plate where said top plate and said bottom plate are positioned on different sides of said vertical plate being defined as an outer section, an accommodating area being formed between said inner section and said bottom plate for accommodating one side of said solar panel, said vertical plate comprising a combined section protruding downwards from said bottom plate, the extending direction of said combined section being parallel to the extending direction of said vertical plate, said vertical plate comprising at least one through hole located in said combined section.

2. The solar panel frame structure as claimed in claim 1, wherein said outer section of said top plate has a bottom side thereof mounted with an elongated sealing member, said sealing member having a middle part thereof provided with an upper protruding portion when viewed from the short axial section thereof, said upper protruding portion being used to be clamped between two adjacent solar panel frame structures.

3. The solar panel frame structure as claimed in claim 1, further comprising a shelf plate added to one side of said combined section, said shelf plate comprising an upper section and a lower section in view of the short axial section thereof, said upper section being provided with a through hole for a bolt to pass through, said lower section being connected to a lower edge of said upper section and extending laterally to one side.

4. The solar panel frame structure as claimed in claim 3, wherein said sealing member comprises a lower protruding portion in the middle thereof.

5. The solar panel frame structure as claimed in claim 3, wherein said top plate of each said side frame comprises a series of locking teeth on a bottom side of said outer section.

6. A solar panel frame structure, comprising:
a solar panel, said solar panel being rectangular in shape with two pairs of opposite sides;
four side frames arranged in two pairs and located on the corresponding sides of said solar panel, each said side frame being in the shape of a long strip, each said side frame comprising a top plate, a vertical plate and a bottom plate respectively set up from top to bottom when viewed from the cross section of the short axis, said top plate being set above said vertical plate, said bottom plate being set on one side of said vertical plate, the section of said top plate where said top plate and said bottom plate are positioned on the same side of said vertical plate being defined as an inner section, the section of said top plate where said top plate and said bottom plate are positioned on different sides of said vertical plate being defined as an outer section, an accommodating area being formed between said inner section and said bottom plate for accommodating one side of said solar panel, said vertical plate comprising a combined section protruding downwards from said bottom plate, the extending direction of said combined section being parallel to the extending direction of said vertical plate, said vertical plate comprising at least one through hole located in said combined section: and
a fixing angle plate provided at the adjacency of each two adjacent said side frames said fixing angle plate comprising a first section and a second section with an included angle defined between said first section and said second section, said first section and said second section being connected to show a L-shaped configuration, said first section and said second section being comprising a mounting groove for the mounting of said vertical plates of said side frames.

7. The solar panel frame structure as claimed in claim 6, wherein said outer section of said top plate has a bottom side thereof mounted with an elongated sealing member, said sealing member having a middle part thereof provided with an upper protruding portion when viewed from the short axial section thereof, said upper protruding portion being used to be clamped between two adjacent solar panel frame structures.

8. The solar panel frame structure as claimed in claim 7, further comprising a shelf plate added to one side of said combined section, said shelf plate comprising an upper section and a lower section in view of the short axial section thereof, said upper section being provided with a through hole for a bolt to pass through, said lower section being connected to a lower edge of said upper section and extending laterally to one side.

9. The solar panel frame structure as claimed in claim 8, wherein said sealing member comprises a lower protruding portion in the middle thereof.

10. The solar panel frame structure as claimed in claim 9, wherein said top plate of each said side frame comprises a series of locking teeth on a bottom side of said outer section.
